(19) United States
(12) Patent Application Publication
(10) Pub. No.: US 2008/0075001 A1
(43) Pub. Date: Mar. 27, 2008

(54) METHOD AND SYSTEM FOR FRAME PROCESSING IN A WIRELESS NETWORK

(75) Inventor: Chih-hao Yeh, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/534,758

(22) Filed: Sep. 25, 2006

(51) Int. Cl. H04L 12/26

(52) U.S. Cl. 370/230

(57) ABSTRACT

A method for frame processing in a wireless network is provided. A receiver receives and forwards a frame to a forwarding logic unit. The forwarding logic unit receives the frame and decides to discard the frame, to forward the frame to a host interface, or to notify a firmware according to predefined forwarding rules. Thus the forwarding logic unit validates and directly forwards the frame to the host interface without firmware intervention.

### BACKGROUND OF THE INVENTION

1. Field of the Invention

The invention relates to data processing, and in particular to a method and system for frame processing in a wireless network, applied to wireless network devices to reduce the number of times for notifying the firmware by a receiver and determine whether a wireless frame is abandoned or forwarded using the forwarding logic according to forwarding rules.

2. Description of the Related Art

FIG. 1 is a schematic view of the conventional architecture of a system for frame processing in a wireless network. FIG. 2 is a flowchart of a conventional method for frame processing in a wireless network. Referring to FIGS. 1 and 2, when a frame is received (step S11), receiver 110 notifies firmware 120 and forwards the frame to firmware 120 (step S12). Next, firmware 120 decides (step S13) whether the frame is forwarded to host interface 130 (step S14) or is discarded (step S15), or further processes are executed (step S16), such as maintaining MIB (Management Information Base) statistics or creating a connection. When firmware 120 forwards the frame to host interface 130, host interface 130 then forwards the frame to host 140.

A wired network node determines its connection with a network according to its physical connection state. Thus, a received frame is forwarded to a host if the target address of the received frame is valid. Because wireless devices do not physically connect with a network, and they may receive frames with management purposes while wired network protocols (such as IEEE 802.3 networks) may only have data frames, a validation of received frames is required before a frame is forwarded to host 140.

For a ASIC based solution, a software device driver resides in the host 140 must determine whether the frame type of a frame belongs to data payload, whether the ToDS/FrDS bits comply with the frame state, whether the frame is sent from a associated network, whether the frame is encrypted according to the security policy of a received station (STA), and what sub-net access protocol (SNAP) value the frame contains.

With respect to a firmware-based wireless solution, the rules described in paragraph [0004] are applied to firmware 120. When a received frame is a data frame and complies with the rules, the frame is then forwarded to host interface 130, resulting in constantly notifying firmware 120 whenever a data frame is received for forwarding. However, once a node is associated with a network, the number of frames with management purposes is far less than the number of data frames. Data frames can be directly forwarded to host but not are forwarded via firmware 120. Hence, a bottleneck from firmware 120 to host 140 may occur if a burst of data frames is generated.

Thus, an improved method and system for frame processing in a wireless network is desirable, enabling a data frames to be directly forwarded to a host but not to be forwarded via the firmware.

### BRIEF SUMMARY OF THE INVENTION

A method for frame processing in a wireless network is provided. A receiver receives and forwards a frame to a forwarding logic unit. The forwarding logic unit receives the frame and decides to discard the frame, to forward the frame to a host interface, or to notify a firmware according to predefined forwarding rules. Thus, the forwarding logic unit validates and directly forwards received data frames to the host interface without firmware intervention. If firmware notification is triggered according to the predefined forwarding rules, the firmware is notified and decides whether the frame is discarded or forwarded to the host interface, or executes further processes.

Additionally, the predefined forwarding rules are stored in a forwarding table, at least comprising a first address (A1), a second address (A2), a third address (A3), a frame type (FT), a to/from distribution system (To/Fr DS), a security status (Sec.), and a sub-net network access protocol (SNAP), and an action fields.

A system for frame processing in a wireless network is provided, comprising a host, a host interface, a firmware, a receiver, and a forwarding logic unit.

The receiver receives from wireless medium and forwards a frame to the forwarding logic unit.

The forwarding logic unit receives the frame and decides to discard the frame, to forward the frame to a host interface, or to notify a firmware according to predefined forwarding rules. The forwarding logic unit validates and directly forwards received frames to the host interface without firmware intervention. If firmware notification is triggered according to the predefined forwarding rules, the firmware is notified and decides whether the frame is discarded or forwarded to the host interface, or executes further processes.

Additionally, the predefined forwarding rules are stored in a forwarding table, comprising a first address (A1), a second address (A2), a third address (A3), a frame type (FT), a to/from distribution system (To/Fr DS), a security status (Sec.), and a sub-net network access protocol (SNAP), and an action fields. The forwarding table further comprises a default row with a default condition, such that, when a frame not corresponding to the forwarding rules is received, the received frame is discarded or forwarded to a host interface, or the firmware is notified.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of the conventional architecture of a system for frame processing in a wireless network;

FIG. 2 is a flowchart of a conventional method for frame processing in a wireless network;

FIG. 3 is a schematic view of an embodiment of the architecture of a system for frame processing in a wireless network;

FIG. 4 is a flowchart of an embodiment of a method for frame processing in a wireless network;

FIG. 5 is a schematic view of an exemplary forwarding rule table;

FIG. 6 is a schematic view of an example of forwarding rule settings in the forwarding rule table; and

FIG. 7 is a schematic view of another example of forwarding rule settings in the forwarding rule table.

### DETAILED DESCRIPTION OF THE INVENTION

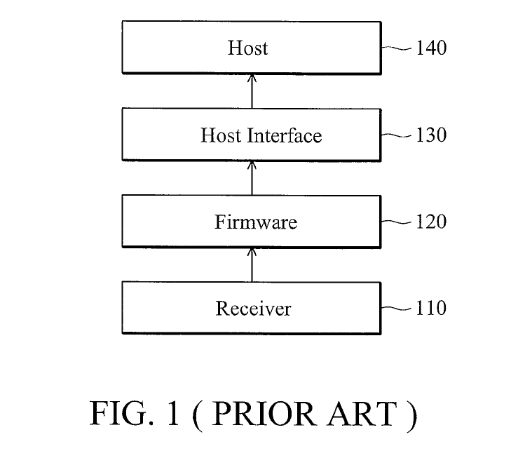

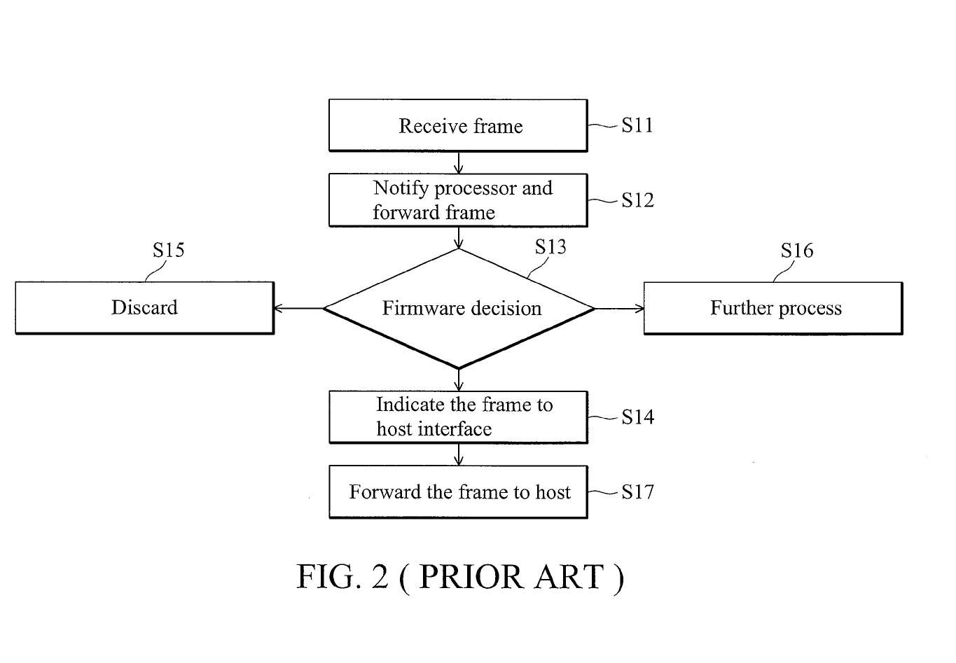

Several exemplary embodiments of the invention are described with reference to FIGS. 1 through 7, which generally relate to frame processing in a wireless network. It is to be understood that the following disclosure provides many different embodiments as examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The invention discloses a method and system for frame processing in a wireless network.

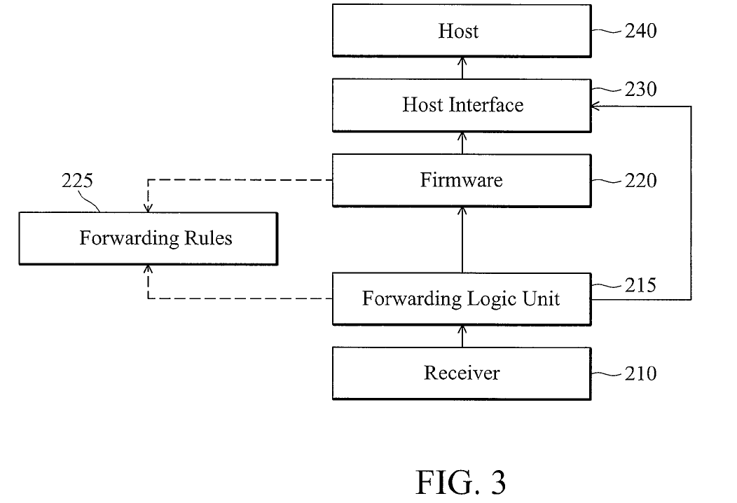

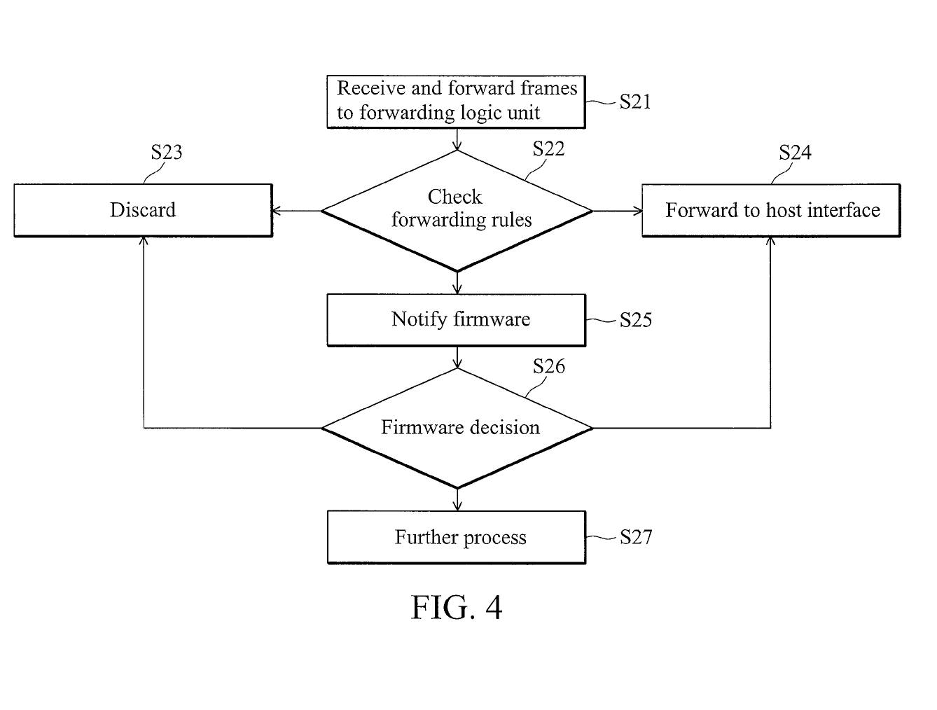

FIG. 3 is a schematic view of an embodiment of the architecture of a system for frame processing in a wireless network. The system comprises a receiver 210, a forwarding logic unit 215, a firmware 220, a host interface 230, and a host 240. FIG. 4 is a flowchart of an embodiment of a method for frame processing in a wireless network. It is noted that forwarding logic unit 215 can, but is not limited to, be Application Specific Integrated Circuit (ASIC) implemented.

Referring to FIGS. 3 and 4, when a frame is received, receiver 210 forwards the frame to forwarding logic unit 215 (step S21). Forwarding logic unit 215 checks forwarding rules 225 (step S22) and decides to discards the frame (step S23), forwards the frame to host interface 230 (step S24), or notifies firmware 220 of the receiving operation (step S25). Thus, forwarding logic unit 215 can validate and directly forward received data frames to host interface 230 without intervention by firmware 220.

When forwarding logic unit 215 notifies firmware 220 of the receiving operation, firmware 220 checks and decides (step S26) whether the frame is discarded (step S23) or forwarded to host interface 230 (step S24), or executes further processes (step S27). Forwarding rules 225 is predefined and stored in a table, indicating a forwarding table. The forwarding table can be stored in a random access memory (RAM), a register, or any other storage medium.

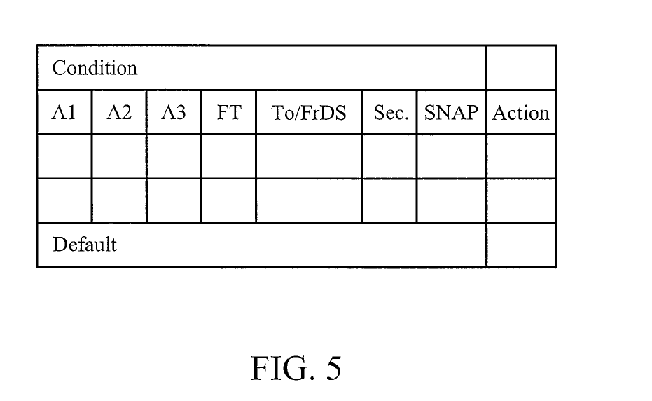

FIG. 5 is a schematic view of an exemplary forwarding rule table.

A forwarding rule table comprises an address 1 (A1), an address 2 (A2), an address 3 (A3), a frame type (FT), a to/from distribution system (To/Fr DS), a security status (Sec.), and a sub-net network access protocol (SNAP) fields acting as conditions, a default field acting as a default condition, and an action field describing an operations corresponding one condition. Thus, the forwarding logic unit implements an operation to a received frame according to the action field. In this embodiment, the forwarding table comprises the described fields but is not to be limitative.

Address fields 1-3 provides source, destination, and transmitter addresses, respectively, depending on the frame control field (the ToDS and FrDS bits). The forwarding rule table may further comprise an address 4 (A4) field to provide a receiver address. The FT field can determine whether a frame type is a management frame, a control frame, or a data frame. Additionally, the ToDS bit is set to 1 when a frame is sent to the distribution system. The FrDS bit is set to 1 when a frame is received from the distribution system.

The following further describes the state change of ToDS and Fr DS bits. The ToDS bit is equal to 0 and the FromDS bit is equal to 0, indicating a frame is direct from one station (STA) to another STA within the same IBSS, as well as all management and control type frames. The ToDS bit is equal to 1 and the FrDS bit is equal to 0, indicating a frame is destined for the DS. The ToDS bit is equal to 0 and the FrDS bit is equal to 1, indicating a frame exits in the DS. The ToDS bit is equal to 1 and the FrDS bit is equal to 1, indicating a wireless distribution system (WDS) frame is distributed from one AP to another AP.

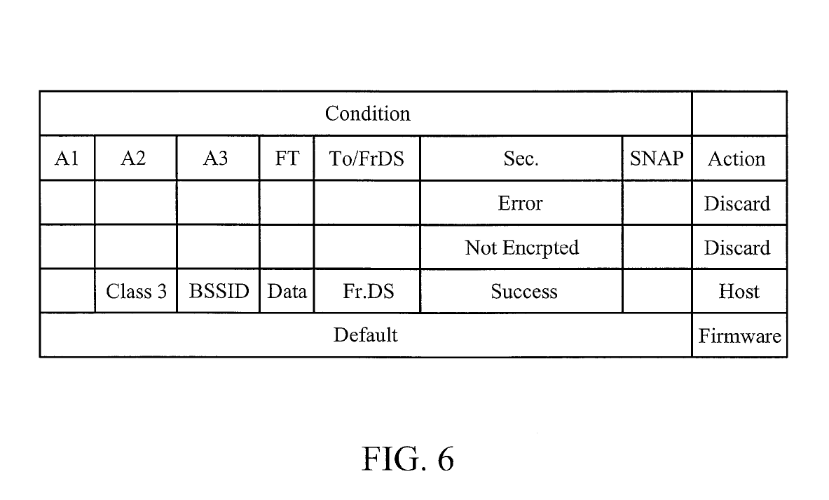

FIG. 6 is a schematic view of an example of forwarding rule settings in the forwarding rule table.

As described, forwarding login unit 215 and firmware 220 must check forwarding rules 225 and execute corresponding operations. Forwarding rules 225 can be user-defined or updated by the firmware 220. Referring to FIG. 6, when an security status error is detected (indicating the security field shows “error”), the frame must be discarded. When a frame is not encrypted (indicating the security field shows “not encrypted”, the frame must be discarded. When the A2 field shows “Class 3”, the A3 field shows “Basic Service Set ID (BSSID)”, the FT field shows “data”, the To/FrDS field shows “FrDS” (indicating the FrDS value is 1), and the security shows “Success”, the frame is forwarded to the host interface. When the frame does not correspond to all the forwarding rules, indicating a default condition is applied, the frame is then forwarded to a firmware.

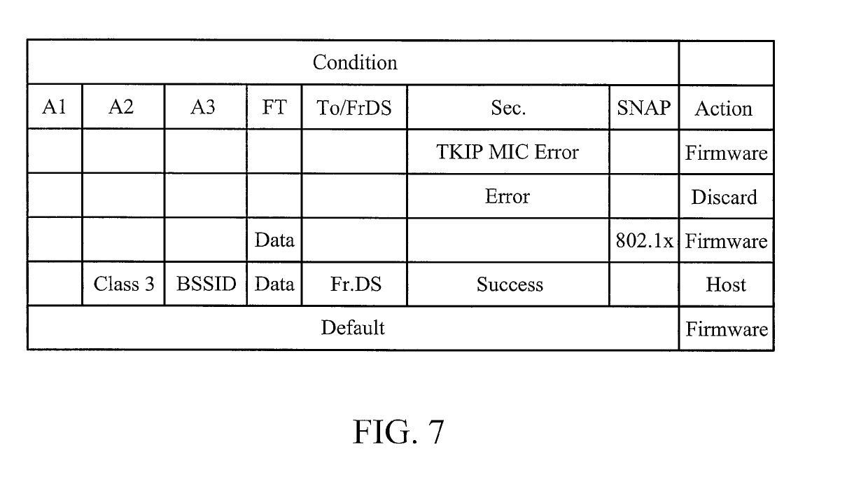

FIG. 7 is a schematic view of another example of forwarding rule settings in the forwarding rule table.

When the security field shows “Temporal Key Integrity Protocol (TKIP) Message Integrity Code (MIC) Error”, the frame is directed to the firmware. When the security field shows “Error”, the frame is discarded. When the FT field shows “Data” and the SNAP field shows “802.1x”, he frame is directed to the firmware. When the A2 field shows “Class 3”, the A3 field shows “Basic Service Set ID (BSSID)”, the FT field shows “data”, the To/FrDS field shows “FrDS” (indicating the FrDS value is 1), and the security shows “Success”, the frame is forwarded to the host interface.

The forwarding rules described in FIGS. 6 and 7 are provided for the purposes of example only and not intended to limit to the invention.

By carefully programming the forwarding rule table, the method for frame processing enables frames with valid data to be directly forwarded to a host interface by forwarding logic unit without firmware intervention. Generally, management type frames and invalid frames are rarely generated, such that the system of the invention can reduce processor power consumption and use less-powerful processor for firmware operations.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for frame processing in a wireless network, comprising:
a receiver receiving and forwarding a frame to a forwarding logic unit; and
the forwarding logic unit receiving the frame and deciding to discard the frame, forward the frame to a host interface, or notify a firmware according to predefined forwarding rules, thereby validating and directly forwarding the received frame to the host interface without intervention of the firmware.

2. The method for frame processing in a wireless network as claimed in claim 1, further comprising:
if firmware notification is implemented, the firmware deciding whether the frame is discarded or forwarded to the host interface, or further processes are executed according to predefined forwarding rules; and
if the frame is forwarded to the host interface, the host interface forwarding the frame to a host.

3. The method for frame processing in a wireless network as claimed in claim 2, wherein the predefined forwarding rules are stored in in a random access memory (RAM), a register, or any other storage medium.

4. The method for frame processing in a wireless network as claimed in claim 2, wherein the firmware logic unit is ASIC implemented.

5. The method for frame processing in a wireless network as claimed in claim 2, wherein the predefined forwarding rules are stored in a forwarding table, comprising a first address (A1), a second address (A2), a third address (A3), a frame type (FT), a to/from distribution system (To/Fr DS), a security (Sec.), and a sub-net network access protocol (SNAP) fields.

6. The method for frame processing in a wireless network as claimed in claim 5, wherein the forwarding table provides actions according to the defined fields.

7. The method for frame processing in a wireless network as claimed in claim 5, wherein the forwarding table further provides a default row with a default condition.

8. The method for frame processing in a wireless network as claimed in claim 7, wherein, when a frame not corresponding to the forwarding rules is received, the firmware logic unit discards or forwards the received frame to the host interface or notifies the firmware according to the default condition.

9. A system for frame processing in a wireless network, comprising:
a host;
a host interface;
a firmware;
a receiver, forwarding a frame; and
a forwarding logic unit, receiving the frame and deciding to discard the frame, forward the frame to a host interface, or notify a firmware according to predefined forwarding rules;
wherein the forwarding logic unit validates and directly forwards the received frame to the host interface without intervention of the firmware.

10. The system for frame processing in a wireless network as claimed in claim 9, wherein, if firmware notification is implemented, the firmware decides whether the frame is discarded or forwarded to the host interface, or further processes are executed according to predefined forwarding rules, and, if the frame is forwarded to the host interface, the host interface forwards the frame to the host.

11. The system for frame processing in a wireless network as claimed in claim 10, wherein the firmware logic unit is ASIC implemented.

12. The system for frame processing in a wireless network as claimed in claim 10, wherein the predefined forwarding rules are stored in a forwarding table, comprising a first address (A1), a second address (A2), a third address (A3), a frame type (FT), a to/from distribution system (To/Fr DS), a security (Sec.), and a sub-net network access protocol (SNAP) fields.

13. The system for frame processing in a wireless network as claimed in claim 12, wherein the forwarding table provides actions according to the defined fields.

14. The system for frame processing in a wireless network as claimed in claim 12, wherein the forwarding table further provides a default row with a default condition.

15. The system for frame processing in a wireless network as claimed in claim 14, wherein, when a frame not corresponding to the forwarding rules is received, the firmware logic unit discards or forwards the received frame to the host interface or notifies the firmware according to the default condition.
